(19) United States
(12) Patent Application Publication
(10) Pub. No.: US 2016/0132843 A1
(43) Pub. Date: May 12, 2016

(54) MyMoney - A computer/mobile device application

(71) Applicant: Zaki Ullah Khan, Surrey (CA)

(72) Inventor: Zaki Ullah Khan, Surrey (CA)

(21) Appl. No.: 14/538,679

(22) Filed: Nov. 11, 2014

(51) Int. Cl. G06Q 20/10; G06Q 20/32

(52) U.S. Cl. CPC G06Q 20/10; G06Q 20/32

(57) ABSTRACT

A system for exchanging/transferring money between individuals or groups through a social mobile device application. Based on a mobile social media platform between known parties for personal and business monetary exchanges and payment transactions. This system will be carried out on computers or mobile devices using an online currency called MyMoney. Users will be able to transfer/pay or exchange funds via this application using the common online currency that they will buy through this application. This system's secondary purpose will be to act as a social media application where users will be able to chat with each other individually, in a group, upload videos, pictures, communicate via voice calls and video call.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING

Not Applicable

### SEQUENCE LISTINGS

Not Applicable

### BACKGROUND OF THE INVENTION

This application was invented to bridge the gap between social media and banking. With millions of smartphone users around the world using various social networks and chat or instant messaging clients like WhatsApp, BBM, Apple iMessage, Facebook, it is overdue that these customers get an easy way to transfer money to their friends via a social media platform. This is currently only done through cash, cheques, debit and credit cards. This application relates to connecting users socially with the primary objective of facilitating payments and exchanges of money via a common currency called ‘MyMoney’. The social aspect of this application would include but not limited to instant messaging, chatting between individuals or groups, uploading pictures, videos and voice and video calls. This application will help users plan outings, discuss office and school work, plan a party or a family get together and buy gifts for each other. For example, at present there is no way for users to pay someone the money owed by them via a social network or IM client application. There is no way to pay towards a fundraiser within a group setting on a chat application. Writing a cheque or going to an ATM can be very inconvenient and outdated in today's technologically advanced world.

Although there are conventional ways of transferring money like bank transfers, wire transfers, email money via a debit account, it takes a lot more time to actually go into these various methods, open the websites or specific applications, logging in and then making sure that the user has separately informed the other user that the money has been transferred. In short, there is no way to transfer or pay money between users via a social media platform where a lot of users are spending a lot of their time. Currently, there is no social media platform or IM client application or a chat platform where users are allowed to perform payment activities or exchanging money between themselves or raise money as a group for fundraising purposes using a common online currency at the click of a button.

### BRIEF SUMMARY OF THE INVENTION

A system for exchanging money between individuals or groups through a social mobile device application. Based on a mobile social media platform between known parties for personal and business monetary exchanges and payment transactions. An example of this process would be to have a social media platform where parties can socialize with each other with the additional and primary feature of paying each other monies owed. This exchange will be carried out with the use of a common online currency called ‘MyMoney’. The parties will be able to buy this online currency within a secured network and transfer or pay another party without disclosing their banking and credit card information. This application will have the secondary purpose of a social network where parties can exchange messages, pictures, video, voice calls and video calls. This application will also facilitate inviting other users to download this application, create groups for chatting purposes and get connected socially or chat individually to each other while having the capability to exchange money via a common online currency called ‘MyMoney’. This invention will help in solving the shortcomings of the existing social media applications that does not allow exchanges of funds using a common online currency. The biggest advantage of this invention is that it will allow the users to not only socially interact with each other but also will allow them to transfer funds among them using a simple online currency.

### BRIEF DESCRIPTION OF THE SEVERAL VIEWS OF THE DRAWINGS

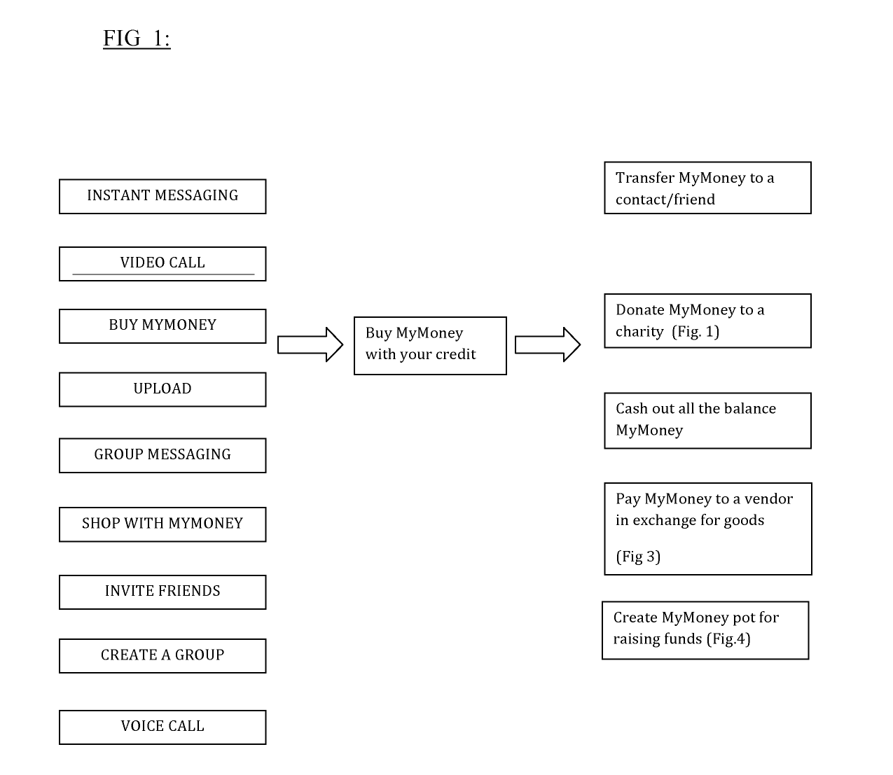

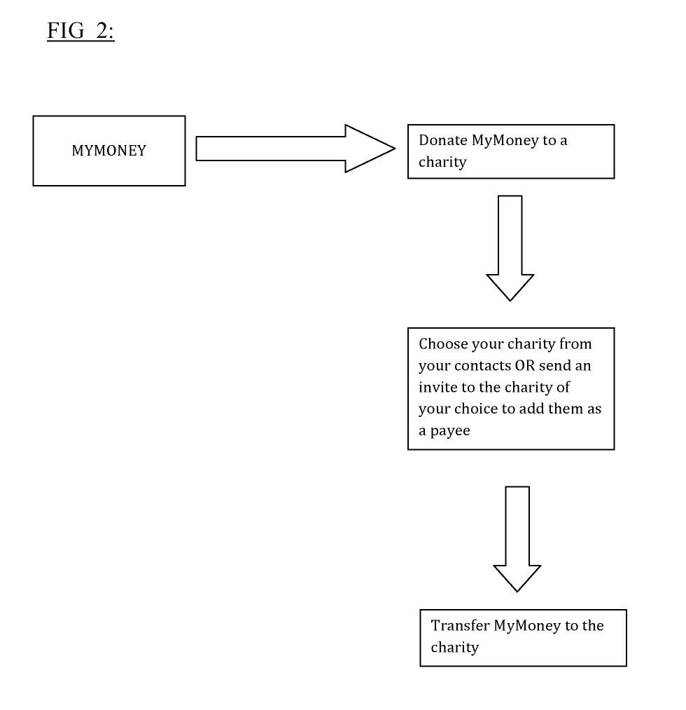

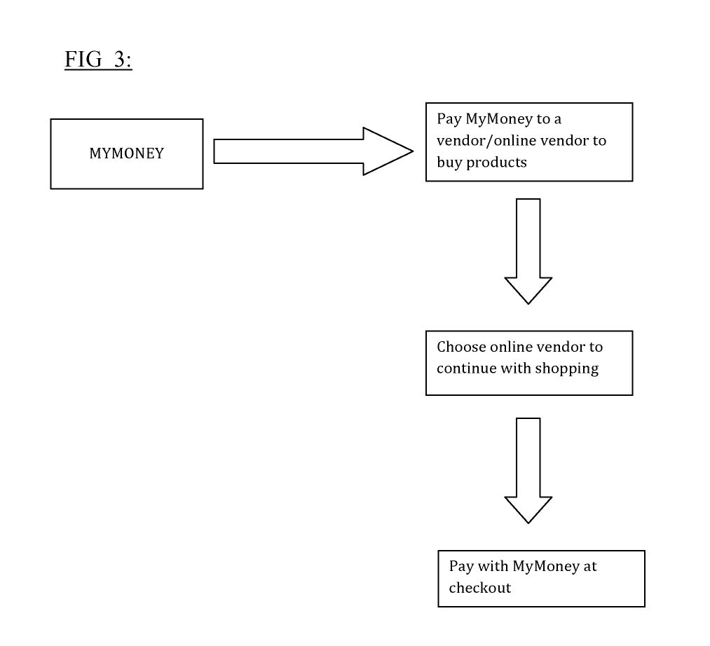

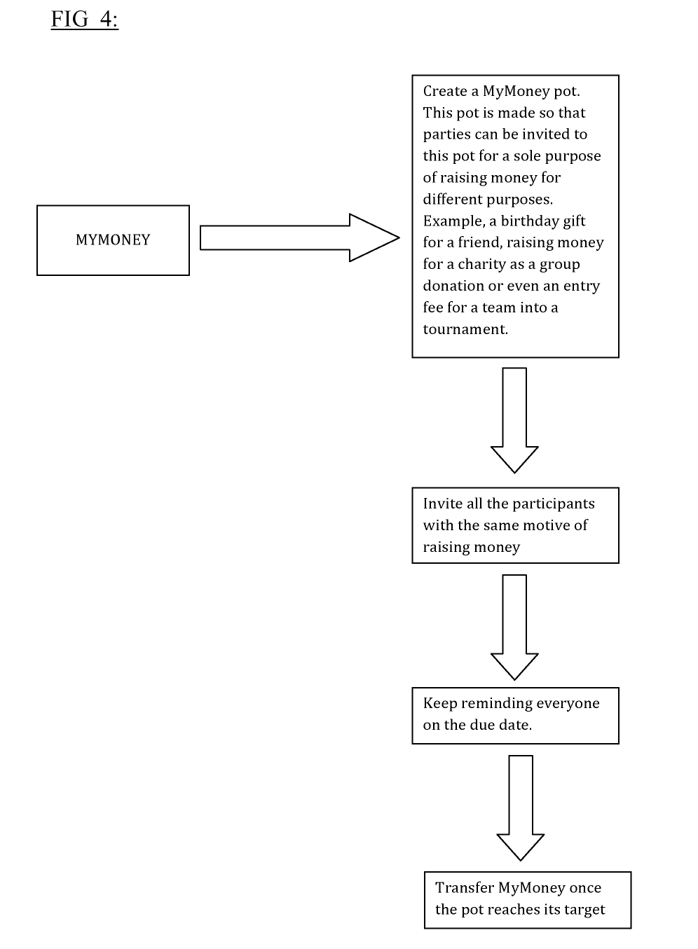

As per the various figures/embodiments described herein, there is a method that explains the process of being able to process payments while still being able to be connected socially with other users and share pictures, videos and chat or voice or video call each other (FIG. 1), donate money (FIG. 2), pay an online vendor (FIG. 3) and collect money in groups in order to pay for an act (FIG. 4). In short, users can do the payments right when they are socially interacting with each other.

### DETAILED DESCRIPTION

Individuals often have trouble exchanging money between those they have social exchanges with that are not vendors that can be paid easily via credit and debit cards. This invention essentially allows all individuals to become vendors and pay, exchange, and give money owed to other users, groups, vendors selling merchandise and fundraising organizations. This invention uses a common online currency called ‘MyMoney’ in order to facilitate the money exchanges, which allows these exchanges to occur without divulging banking information of either party involved.

The present invention relates to a method of transferring money owing between two parties for example between two individuals, or between a buyer and a vendor. This system will also facilitate raising funds individually paying towards an already formed fundraising group or raising funds within an existing group and transferring the collected money to the fundraiser.

All these transfers, payment and collection of money will be done via a common mobile application which will be downloaded by the parties involved. Once the account is set up the users will then have to buy the online currency called ‘MyMoney’ from the application in order to pay or transfer the funds to another user. Individuals in a mobile chat group can use this mobile application without the use of physical money being necessary. Individuals do not require sharing their banking information to facilitate these transactions as well.

The value of ‘MyMoney’ would be worth exactly the value to the currency of the country it is being dealt in. For example, in Canada 1 ‘MyMoney’ will be equal to CAD$1, similarly in the USA 1 ‘MyMoney’ will be equal to US$1. ‘MyMoney’ will not change its value as far as it is dealt within the same country. However, when being transferred from one country to another it will change its value based on the exchange rates between the two countries involved at the time of the exchange.

As per the various figures/embodiments described herein, there is a method that explains the process of being able to process payments while still being able to be connected socially with other users and share pictures, videos and chat or voice or video call each other (FIG. 1), donate money (FIG. 2), pay an online vendor (FIG. 3) and collect money in groups in order to pay for an act (FIG. 4). In short, users can do the payments right when they are socially interacting with each other.

One embodiment relates to allowing a user to setup a group environment to obtain donations and make payments associated to raising funds within or outside of the group setting in order to buy gifts or donate the money raised towards the charity. This further relates to a sort of pot of ‘MyMoney’ being formed for the purpose of raising funds which will show the target funds that need to be raised and how much money has been raised so far. It will also show the date by which all the funds need to be raised and who has participated for the cause so far. This embodiment will also include a section for pledges so that the users who pledge towards the fund raiser will get a reminder to actually realize the pledge before the fundraising closes.

A second embodiment of the application will be set up in such a way that the user of this application will be able to invite others to download this application. Different users will then be able to initiate a chat or messaging session and share pictures and videos. These exchanges would be facilitated with individuals or groups of different users. All the data exchanged may include, but not limited to, images, videos, user profile, user preferences, search keywords, products reviews, feedbacks, chat messages, video messages, and search queries. All the user information and habits generated by the user or groups can be maintained on the network based provider, however, all the data, as per above, may or may not be publicly shared as determined by the generator of the data.

A third embodiment relates to the marketplace, as in vendors that will have an account with this application and will accept ‘MyMoney’ as a form of payment. Vendors can then advertise their products, specials and sales within a tab of this social media application. The vendors will have the ability to give larger discounts depending on how many people within the social network bought that product. Users will also have the ability to share what they bought from the vendor and share the reviews accordingly.

Although embodiments of the present invention has been described with reference to specific example embodiments, it will be evident that various modifications and changes may be made to these embodiments without departing from the broader scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived from them. Structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Thus, a method and apparatus for processing payment transactions from a chat application integrated with a payment application that leverages social features from the chat application is disclosed. Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A method of transferring funds in a mobile device based money transfer system using a mobile common online/electronic currency within the social media application wherein this application will have the secondary purpose of a social network where parties can exchange messages, pictures, video, voice calls and video calls. This application will have a method comprising the steps of:
Receiving a request for an amount of online/electronic funds.
Debiting the amount of funds from a mobile device based money transfer system account.
Using the mobile application to identify an account on a payment site that corresponds to the payment request.
Performing a payment transaction with the identified account corresponding to the payment request at the payment site via the payment application.
Providing a social platform to everyone who downloads the application of not only that of a money exchanging/transferring channel but also of a social network/media wherein all the parties can exchange messages, pictures, video, voice calls and video calls.

2. The method of claim 1 further comprising the step of receiving real funds with the request for electronic funds.

3. The method as claimed in claim 1 including validating the account on the payment site using the payment application.

4. The method as claimed in claim 1 including enabling the client user to select a payee from a contact list of the application.

5. The method as claimed in claim 1 wherein the application is a downloadable application on a mobile device.

6. The method as claimed in claim 1 including notifying the client user when the payment transaction is complete

7. The method as claimed in claim 1 including sending an email to the client user when the payment transaction is complete.

8. The method as claimed in claim 1 including inviting the client user to log-in the application.

9. The method as claimed in claim 1 wherein the application with the integrated payment application being further configured to facilitate social sharing functions including: exchanging messages, pictures, video, voice calls, video calls, inviting users to download the payment application, sharing a contact list among a plurality of payment application users, inviting users to chat right from the payment application, and updating a user profile in the application by the payment application

10. The method of claim 1, wherein the request is received from a mobile device.

11. A system for transferring funds in a mobile device based money transfer system comprising logic configured to:
receive a request for an amount of electronic funds;

12. The system of claim 11 further comprising:
a cellular interface configured to communicate with the mobile device based money transfer system.

13. The system of claim 11, wherein the mobile device based money transfer system and the online currency/electronic funds is ‘MyMoney’.

14. A computer program comprising program instructions that, when executed on a computer cause the computer to perform the method of claim 1.

15. A computer-readable medium carrying a computer program according to claim 14.

16. A computer programmed to perform the method of claim 1.
